(19) United States
(12) Patent Application Publication
(10) Pub. No.: US 2013/0135719 A1
(43) Pub. Date: May 30, 2013

(54) STEREO DISPLAY DEVICE AND PARALLAX BARRIER PANEL THEREOF

(71) Applicant: Au Optronics Corporation, Hsinchu (TW)

(72) Inventor: Meng-Chieh Tsai, New Taipei City (TW)

(73) Assignee: AU OPTRONICS CORPORATION, Hsinchu (TW)

(21) Appl. No.: 13/677,307

(22) Filed: Nov. 15, 2012

(30) Foreign Application Priority Data
Nov. 30, 2011 (TW) 100143984

(51) Int. Cl. G02B 27/22

(52) U.S. Cl. CPC G02B 27/2214
USPC 359/462

(57) ABSTRACT

A stereo display device includes a display panel and a parallax barrier panel. The display panel includes a pixel array having pixel units, each of which includes sub-pixels. The parallax barrier panel at one side of the display panel includes a first substrate, first electrodes, second electrodes, a second substrate, third electrodes, fourth electrodes, and a birefringence medium. The first and second electrodes are arranged on the first substrate alternately; an extension direction of the first and second electrodes is parallel to the X-direction. The third and fourth electrodes are arranged on the second substrate alternately; an extension direction of the third and fourth electrodes is not parallel to the X-direction; an included angle between the extension direction of the third and fourth electrodes and the Y-direction is substantially greater than 0° and smaller than 45°. The birefringence medium is disposed between the first and second substrates.

### CROSS-REFERENCE TO RELATED APPLICATION

This application claims the priority benefit of Taiwan application serial no. 100143984, filed on Nov. 30, 2011. The entirety of the above-mentioned patent application is hereby incorporated by reference herein and made a part of this specification.

### BACKGROUND OF THE INVENTION

1. Field of the Invention

The invention relates to a stereo display. More particularly, the invention relates to a stereo display with a parallax barrier.

2. Description of Related Art

At present, three-dimensional (3D) display technologies can be roughly categorized into auto-stereoscopic technologies that allow a viewer to directly watch images with naked eyes and stereoscopic technologies that require the viewer to wear specially designed glasses. According to the operational principle of an auto-stereoscopic display device, a fixed barrier is utilized to control images received by left and right eyes of the viewer. However, according to visual characteristics of human eyes, when two images with the same content but different parallax are respectively captured by a viewer's left and right eyes, two images that seem to be overlapped may be interpreted as a 3D image. Besides, according to the operational principle of a stereoscopic stereo display device, the display device displays left-eye and right-eye frames that can be respectively sent to the left and right eyes of the viewer who wears glasses, so as to generate a 3D image.

From another perspective, a number of existing stereo displays are capable of providing a portrait display mode and a landscape display mode. Nonetheless, most of these stereo displays encounter the color shift issue, and the problem of color aberration occurs if the viewer watches images at different viewing angles. As a result, the existing stereo displays capable of providing the portrait display mode and the landscape display mode still have room for improvement.

### SUMMARY OF THE INVENTION

The invention is directed to a stereo display and its parallax barrier panel able to improve stereo display effects accomplished by an existing stereo display that is capable of providing a portrait display mode and a landscape display mode.

In the invention, a stereo display including a display panel and a parallax barrier panel is provided. The display panel includes a pixel array having a plurality of pixel units, each of the pixel units includes a plurality of sub-pixels, and the sub-pixels are arranged along an X-direction and an Y-direction to form the pixel array. The parallax barrier panel is located at one side of the display panel and includes a first substrate, a plurality of first electrodes, a plurality of second electrodes, a second substrate, a plurality of third electrodes, a plurality of fourth electrodes, and a birefringence medium. The first electrodes and the second electrodes are arranged on the first substrate alternately, and an extension direction of the first electrodes and the second electrodes is parallel to the X-direction. The second substrate is located opposite to the first substrate. The third electrodes and the fourth electrodes are arranged on the second substrate alternately. An extension direction of the third electrodes and the fourth electrodes is not parallel to the X-direction, and an included angle θ between the Y-direction and the extension direction of the third electrodes and the fourth electrodes is substantially greater than 0° and smaller than 45°. The birefringence medium is disposed between the first substrate and the second substrate. Besides, the first electrodes, the second electrodes, and the third electrodes are electrically connected to a first voltage, and the fourth electrodes are electrically connected to a second voltage. Alternatively, the second electrodes, the third electrodes, and the fourth electrodes are electrically connected to the first voltage, and the first electrodes are electrically connected to the second voltage.

In the invention, a parallax barrier panel that includes a first substrate, a plurality of first electrodes, a plurality of second electrodes, a second substrate, a plurality of third electrodes, a plurality of fourth electrodes, and a birefringence medium is provided. The first electrodes and the second electrodes are arranged on the first substrate alternately, and an extension direction of the first electrodes and the second electrodes is parallel to the X-direction. The second substrate is located opposite to the first substrate. The third electrodes and the fourth electrodes are arranged on the second substrate alternately. An extension direction of the third electrodes and the fourth electrodes is not parallel to the X-direction, and an included angle θ between the Y-direction and the extension direction of the third electrodes and the fourth electrodes is substantially greater than 0° and smaller than 45°. The birefringence medium is disposed between the first substrate and the second substrate. Besides, the first electrodes, the second electrodes, and the third electrodes are electrically connected to a first voltage, and the fourth electrodes are electrically connected to a second voltage. Alternatively, the second electrodes, the third electrodes, and the fourth electrodes are electrically connected to the first voltage, and the first electrodes are electrically connected to the second voltage.

Based on the above, the extension direction of the first and second electrodes on the first substrate is parallel to the X-direction, the extension direction of the third and fourth electrodes on the second substrate is not parallel to the X-direction, and there is an included angle θ between the Y-direction and the extension direction of the third and fourth electrodes. Hence, through the arrangement of the first, second, third, and fourth electrodes and connection of these electrodes to certain voltages, the parallax barrier effects required by stereo display can be achieved, and the color aberration problem is less likely to occur. Thereby, favorable stereo display performance can be further ensured.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic cross-sectional view illustrating a stereo display according to an embodiment of the invention.

FIG. 2 is a schematic structural view illustrating a pixel array of a display panel according to an embodiment of the invention.

FIG. 3A is a schematic top view illustrating a parallax barrier panel according to an embodiment of the invention.

FIG. 3B is a schematic structural view illustrating a data arrangement of the pixel array according to an embodiment of the invention.

FIG. 3C is a schematic top view illustrating that the parallax barrier panel described in the present embodiment is in a portrait display mode.

FIG. 3D is a schematic cross-sectional view illustrating the stereo display of the present embodiment taken along a section line A-A′ in FIG. 3C.

FIG. 3E is a schematic top view illustrating that the parallax barrier panel described in the present embodiment is in a landscape display mode.

FIG. 3F is a schematic cross-sectional view illustrating the stereo display of the present embodiment taken along a section line B-B′ in FIG. 3E.

FIG. 4A is a schematic top view illustrating a pixel array according to another embodiment of the invention.

FIG. 4B is a schematic top view illustrating the parallax barrier panel described in the present embodiment.

FIG. 5A illustrates a parallax barrier panel according to another embodiment of the invention.

FIG. 5B is a schematic top view illustrating a pixel array according to another embodiment of the invention.

FIG. 6 is a schematic top view illustrating a parallax barrier panel according to an embodiment of the invention.

FIG. 7 is a schematic top view illustrating a parallax barrier panel according to an embodiment of the invention.

FIG. 8 is a schematic top view illustrating a parallax barrier panel according to an embodiment of the invention.

### DESCRIPTION OF EMBODIMENTS

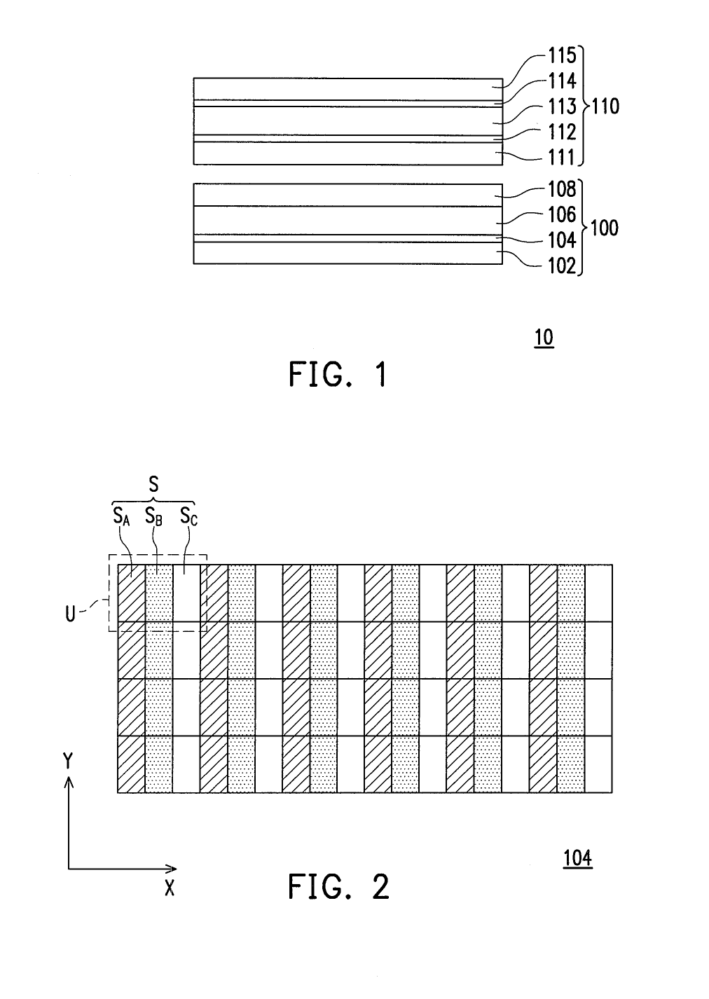

FIG. 1 is a schematic cross-sectional view illustrating a stereo display 10 according to an embodiment of the invention. With reference to FIG. 1, the stereo display 10 of this embodiment includes a display panel 100 and a parallax barrier panel 110 that is located at one side of the display panel 100. The display panel 100 includes a lower substrate 102, a pixel array 104, a display medium 106, and an upper substrate 108. The pixel array 104 is disposed on the lower substrate 102. The upper substrate 108 is disposed opposite to the lower substrate 102. The display medium 106 is located between the upper substrate 108 and the lower substrate 102. Besides, the display panel 100 can be any display panel that can display images. For instance, the display panel 100 can be a liquid crystal display (LCD) panel, an organic electroluminescent display (OELD) panel, an electrophoretic display panel, or any other display panel. The display medium 106 of an exemplary LCD panel includes liquid crystal molecules.

FIG. 2 is a schematic structural view illustrating the pixel array 104 of the display panel 100 according to the present embodiment. With reference to FIG. 2, the pixel array 104 of the present embodiment has a plurality of pixel units U, each of which includes a plurality of sub-pixels S. The sub-pixels S include a first color sub-pixel S_{A}, a second color sub-pixel S_{B}, and a third color sub-pixel S_{c}, and the first, second, and third sub-pixels S_{A}, S_{B}, and S_{C} are red, green, and blue sub-pixels, for instance. These sub-pixels S_{A}, S_{B}, and S_{C} are arranged along an X-direction and an Y-direction to form the pixel array 104. Specifically, the pixel array 104 has a plurality of columns in the Y-direction and a plurality of rows in the X-direction, and the sub-pixels S_{A}, S_{B}, and S_{C} located on the same column have identical color. In other words, the sub-pixels S_{A} (or S_{B} or S_{C}) with the same color are arranged in the same column, and the sub-pixels S_{A}, S_{B}, and S_{C} with different colors are sequentially arranged in the same row. Here, an extension direction in which the sub-pixels S_{A} (or S_{B} or S_{C}) with the same color are arranged is defined as the Y-direction, and an extension direction in which the sub-pixels S_{A}, S_{B}, and S_{C} with different colors are sequentially arranged is defined as the X-direction.

As shown in FIG. 1, the parallax barrier panel 110 includes a first substrate 111, a first electrode layer 112, a birefringence medium 113, a second electrode layer 114, and a second substrate 115. The first substrate 111 and the second substrate 115 are configured opposite to each other and can be made of glass, quartz, organic polymer, or any other appropriate material. The birefringence medium 113 is located between the first substrate 111 and the second substrate 115. Besides, the birefringence medium 113 includes liquid crystal molecules or other appropriate substance. The liquid crystal molecules taken as an example here often have a first axial refractive index (no) and a second axial refractive index (ne). The first axial refractive index (no) may be referred to as a short axial refractive index of the liquid crystal molecules, and the second axial refractive index (ne) may be referred to as a long axial refractive index of the liquid crystal molecules. In addition, the birefringence medium 113 is arranged based on the electric field distribution in the parallax barrier panel 110. The first electrode layer 112 and the second electrode layer 114 are respectively located on the first substrate 111 and the second substrate 115 and are on the inner sides of the first substrate 111 and the second substrate 115 so as to be located adjacent to the birefringence medium 113. A material of the first electrode layer 112 and the second electrode layer 114 includes a transparent conductive material, e.g., a metal oxide including indium tin oxide (ITO), indium zinc oxide (IZO), aluminum zinc oxide (AZO), aluminum tin oxide (ATO), indium germanium zinc oxide (IGZO), other suitable oxides, or a stacked layer having at least two of the above-mentioned materials.

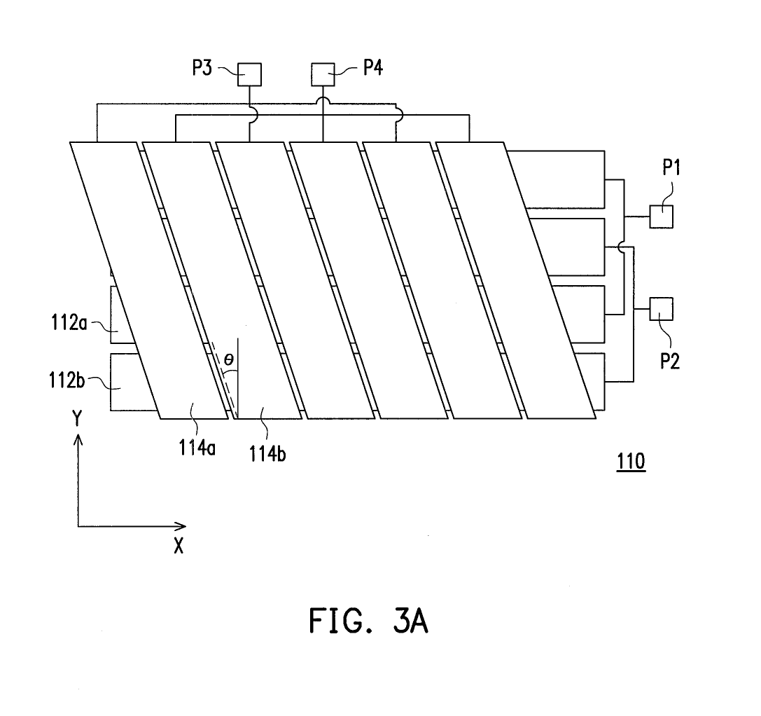

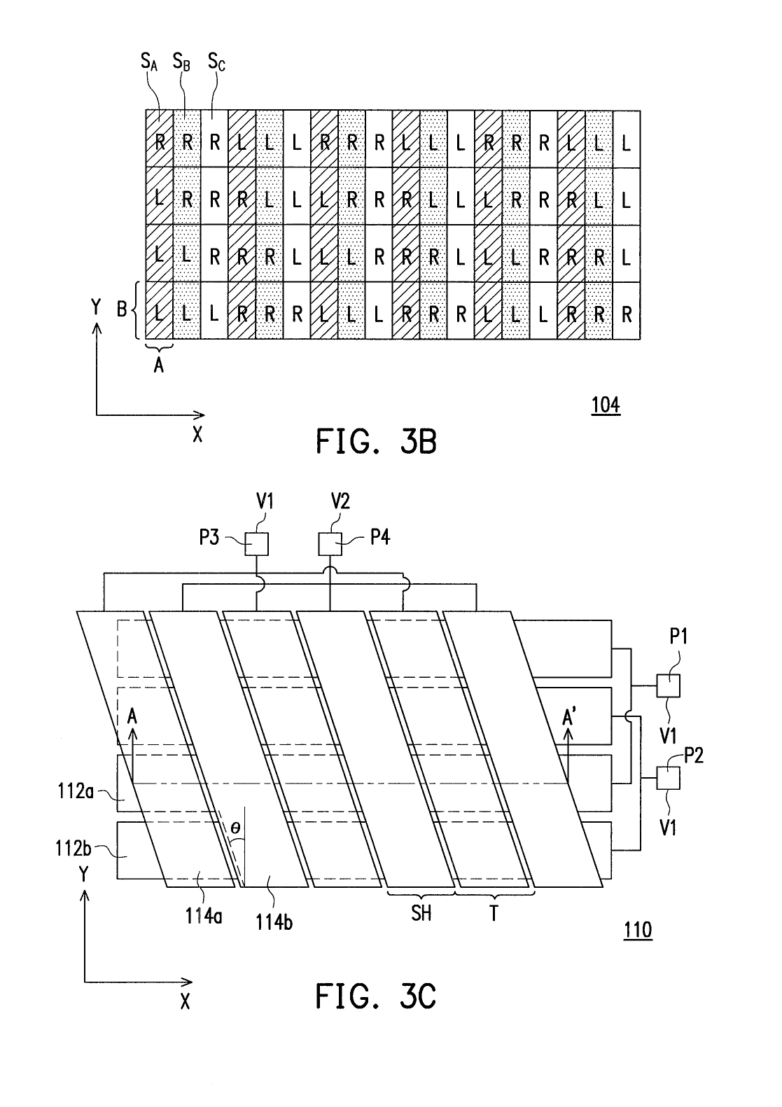

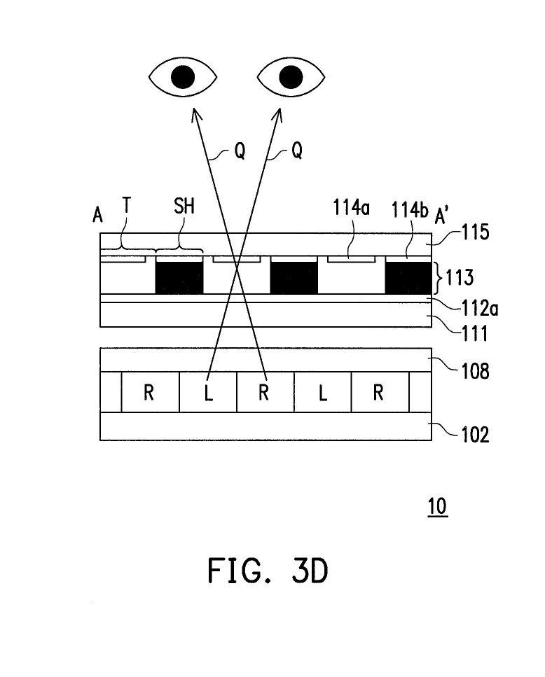

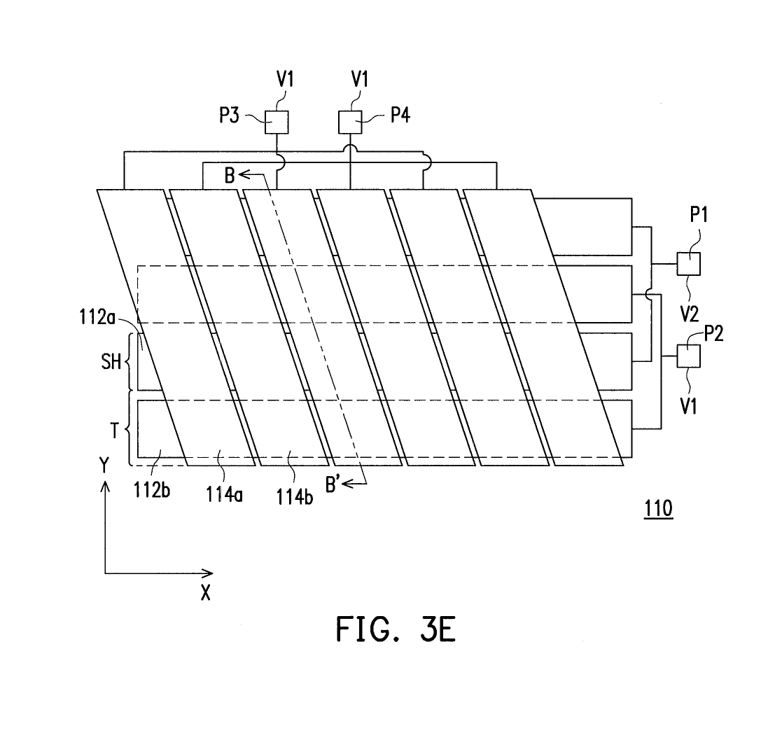

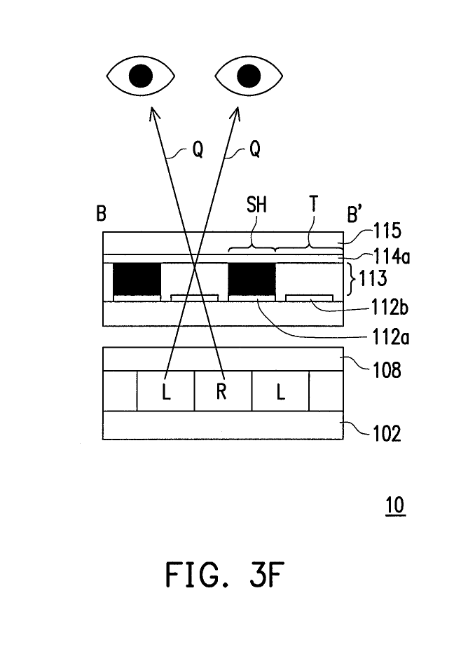

FIG. 3A is a schematic top view illustrating the parallax barrier panel 110 described in the present embodiment. To clearly show the electrode film layers in the parallax barrier panel, the first substrate 111, the second substrate 115, and the birefringence medium 113 are omitted in FIG. 3A. With reference to FIG. 1 and FIG. 3A, the first electrode layer 112 includes a plurality of first electrodes 112a and a plurality of second electrodes 112b, the first electrodes 112a and the second electrodes 112b are arranged on the first substrate 111 alternately, and an extension direction of the first electrodes 112a and the second electrodes 112b is parallel to the X-direction. The second electrode layer 114 includes a plurality of third electrodes 114a and a plurality of fourth electrodes 114b, and the third electrodes 114a and the fourth electrodes 114b are arranged on the second substrate 115 alternately. An extension direction of the third electrodes 114a and the fourth electrodes 114b is not parallel to the X-direction, and an included angle θ between the Y-direction and the extension direction of the third electrodes 114a and the fourth electrodes 114b is substantially greater than 0° and smaller than 45°. In addition, the first electrodes 112a, the second electrodes 112b, the third electrodes 114a, and the fourth electrodes 114b are electrically connected to the corresponding input pads P1, P2, P3, and P4, respectively.

FIG. 3B is a schematic structural view illustrating a data arrangement of the pixel array 104 described in the present embodiment. To elaborate the arrangement of electrodes with an inclined included angle θ in the parallax barrier panel 110 of the present embodiment, the structure of the pixel array 104 in the display panel 100 can be further depicted in FIG. 3B. With reference to FIG. 3B, the sub-pixels S_{A}, S_{B}, and S_{C} in the pixel array 104 may be further divided into pixel regions L for the left eye of a viewer and pixel regions R for the right eye of the viewer, and the pixel regions L and R are arranged stepwise. For instance, the range of the pixel regions L for the left eye of a viewer is sequentially moved to the right by one sub-pixel S from top to bottom. Hence, the pixel regions L are overall arranged in a stepwise manner.

FIG. 3C is a schematic top view illustrating that the parallax barrier panel 110 described in the present embodiment is in a portrait display mode. FIG. 3D is a schematic cross-sectional view illustrating the stereo display 10 of the present embodiment taken along a section line A-A′ in FIG. 3C. With reference to FIG. 3C and FIG. 3D, if it is intended to display a stereo image on the stereo display 10, the first electrodes 112a, the second electrodes 112b, and the third electrodes 114a in the parallax barrier panel 110 may be electrically connected to a first voltage V1, and the fourth electrodes 114b may be electrically connected to a second voltage V2. Note that there is a voltage difference between the first voltage V1 and the second voltage V2, i.e., the first voltage V1 is not equal to the second voltage V2. Since the birefringence medium 113 located between the first substrate 111 and the second substrate 115 is arranged based on the electric field distribution, the birefringence medium 113 located between the fourth electrodes 114b and the first and second electrodes 112a and 112b may encounter an issue of variations in the electric field caused by the voltage difference, and thereby the birefringence medium 113 does not allow light to pass through. As a result, the fourth electrodes 114b form a shielding region SH. By contrast, the birefringence medium 113 located between the third electrodes 114a and the first and second electrodes 112a and 112b does not encounter the issue of variations in the electric field due to lack of voltage difference, and thus the birefringence medium 113 stays in a light-transmissible state. As a result, the third electrodes 114a allow light Q of the pixels to pass through to form a light transmissive region T, such that the left eye and the right eye of a viewer can observe the corresponding pixel regions L and R, respectively.

FIG. 3E is a schematic top view illustrating that the parallax barrier panel 110 described in the present embodiment is in a landscape display mode. FIG. 3F is a schematic cross-sectional view illustrating the stereo display 10 of the present embodiment taken along a section line B-B′ in FIG. 3E. The arrangement of the pixel array 104 refers to a lateral row arrangement in the present embodiment. For instance, the range of the pixel regions L for the left eye of a viewer is defined by sequentially arranging the sub-pixels S from left to right. Hence, the pixel regions L and R are overall arranged alternately in a column direction. With reference to FIG. 3E and FIG. 3F, the second electrodes 112b, the third electrodes 114a, and the fourth electrodes 114b in the parallax barrier panel 110 are electrically connected to the first voltage V1, and the first electrodes 112a may be electrically connected to the second voltage V2. Note that there is a voltage difference between the first voltage V1 and the second voltage V2, i.e., the first voltage V1 is not equal to the second voltage V2. Therefore, the birefringence medium 113 located between the first electrodes 112a and the third and fourth electrodes 114a and 114b encounters the issue of variations in the electric field caused by the voltage difference, and thus the birefringence medium 113 does not allow light to pass through. As a result, the first electrodes 112a form a shielding region SH. By contrast, the birefringence medium 113 located between the second electrodes 112b and the third and fourth electrodes 114a and 114b does not encounter the issue of variations in the electric field because these electrodes are electrically connected to the same voltage, such that the birefringence medium 113 stays in a light-transmissible state. As a result, the second electrodes 112b allow the light Q of the pixels to pass through to form a light transmissive region T, so as to enable the left eye and the right eye of a viewer to observe the corresponding pixel regions L and R, respectively.

With reference to FIG. 3A and FIG. 3B, each of the pixel units U in the parallax barrier panel 110 includes a first color sub-pixel S_{A}, a second color sub-pixel S_{B}, and a third color sub-pixel S_{C} sequentially arranged along the X-direction in the present embodiment. Additionally, each of the sub-pixels S_{A} (or S_{B} or S_{C}) has a short-side length A and a long-side length B and the included angle θ between the Y-direction and the extension direction of the third electrodes 114a and the fourth electrodes 114b is determined by the short-side length A and the long-side length B, i.e., the included angle θ=tan⁻¹(A/B). In the present embodiment, the short-side length A of each sub-pixel S is one third the long-side length B, and thus the included angle θ between the Y-direction and the extension direction of the third electrodes 114a and the fourth electrodes 114b satisfies θ=tan⁻¹(1/3)=18.43°. However, the invention is not limited thereto, and each of the pixel units includes sub-pixels with four different colors in another embodiment of the invention. That is to say, people having ordinary skill in the art may, based on the properties of products and actual requirements, determine the required number of sub-pixels S in each of the pixel units U, the short-side length A of each sub-pixel S, and the long-side length B of each sub-pixel S, and the angle at which the electrodes are supposed to incline may be obtained if the included angle θ is equal to tan⁻¹(A/B).

It should be mentioned that the reference numbers and some of the descriptions in the previous embodiment are applicable in the following embodiments. Identical or similar components in the previous and following embodiments are denoted by identical reference numbers, and the same descriptions in the previous and following embodiments are not reiterated herein. Specifically, these identical or similar components can be learned from the explanation in the previous embodiment, and thus no other descriptions are provided below.

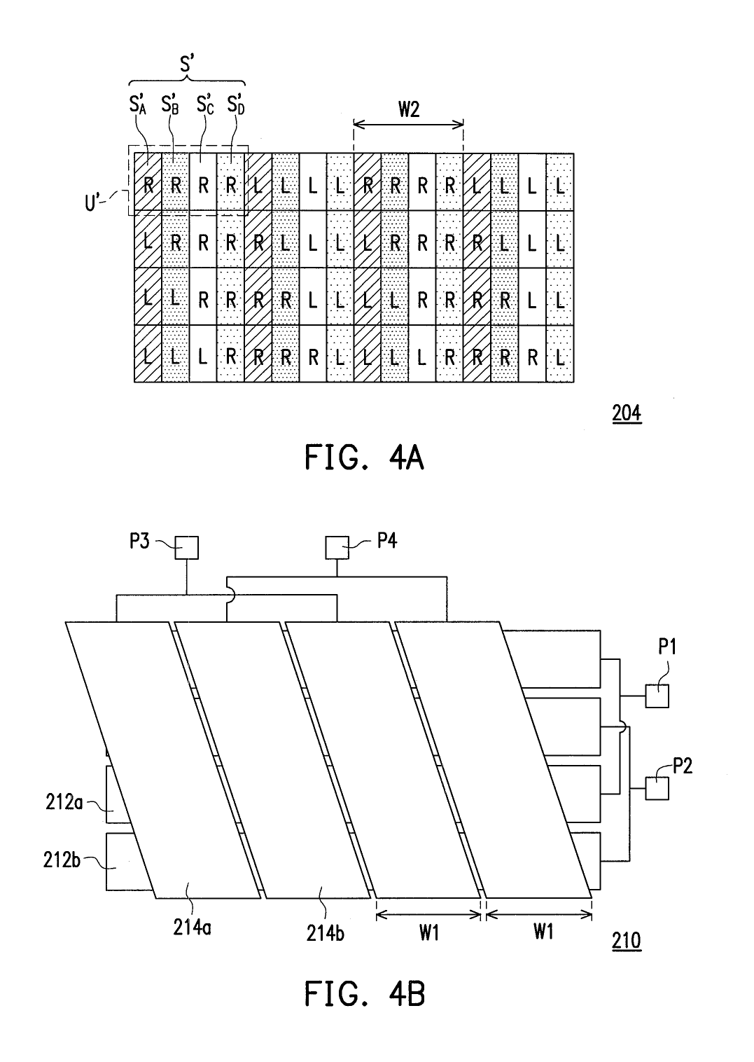

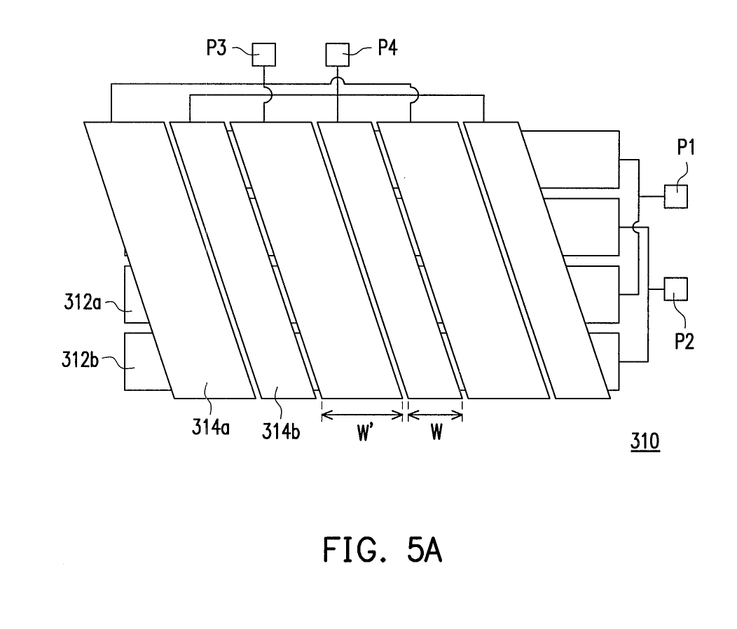

FIG. 4A is a schematic top view illustrating a pixel array 204 according to another embodiment of the invention. The display mode and the components of the stereo display in the present embodiment and those of the stereo display 10 in the previous embodiment are mostly the same, while the difference therebetween lies in the structure of the pixel array 204. FIG. 4B is a schematic top view illustrating the parallax barrier panel 210 described in the present embodiment. With reference to FIG. 4A and FIG. 4B, the pixel array 204 in the present embodiment has a plurality of pixel units U′, and each of the pixel units U′ includes a first color sub-pixel S′_{A}, a second color sub-pixel S′_{B}, a third color sub-pixel S′_{C}, and a fourth color sub-pixel S′_{D} sequentially arranged along the X-direction. When each of the pixel units U′ in the pixel array 204 is composed of four sub-pixels S′, a horizontal width W1 of the third electrodes 214a and the fourth electrodes 214b may be properly adjusted corresponding to a width W2 of the pixel units U′. Specifically, the horizontal width W1 of the third electrodes 214a and the fourth electrodes 214b is substantially shorter than or equal to the width W2 of the pixel units U′. Thereby, the third electrodes 214a and the fourth electrodes 214b are able to provide the pixel array 204 with the appropriate parallax barrier. Namely, the number of the sub-pixels S′ in each pixel unit U′ is not limited in the invention.

The electrical connection of components in the display panel in the portrait display mode and in the landscape display mode described in the present embodiment is similar to that described in the previous embodiment and thus will not be reiterated hereinafter.

In the previous embodiment, the horizontal width of the third electrodes 114a is the same as the horizontal width of the fourth electrodes 114b. To improve the display performance of the stereo display in the invention, the horizontal width of the electrodes is further modified in another embodiment of the invention. In addition, the components of the stereo display and the operation of the display panel in the portrait display mode and in the landscape display mode as provided in the present embodiment are similar to those described in the previous embodiments and thus will not be reiterated hereinafter. It should be mentioned that the descriptions regarding the width of the electrodes in the present embodiment serve to explain in detail the features of the parallax barrier panel 310, so as to further resolve the color aberration issue of the stereo display and enable people having ordinary skill in the art to implement the invention, which should however not be construed as a limitation to the invention.

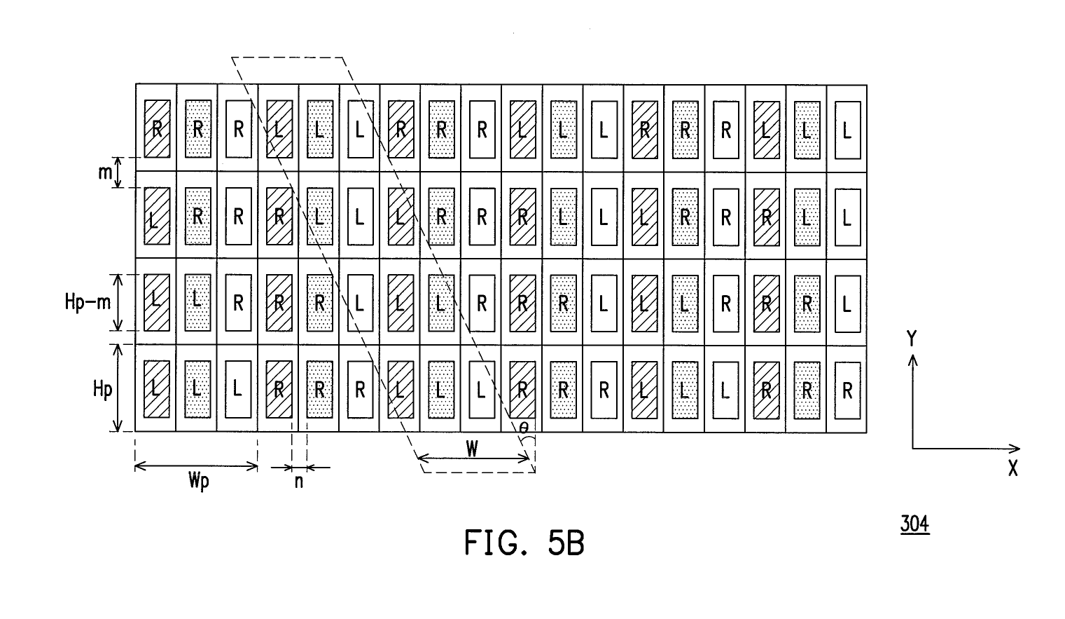

FIG. 5A illustrates a parallax barrier panel 310 of the embodiment of the invention. FIG. 5B is a schematic structural view illustrating a pixel array 304 of the present embodiment. With reference to FIG. 5A, the difference between the parallax barrier panel 310 of the present embodiment and the parallax barrier panels 110 and 210 of the previous embodiments lies in that a horizontal width W of the fourth electrodes 314b in the parallax barrier panel 310 is substantially shorter than a horizontal width W′ of the third electrodes 314a. Please refer to FIG. 5B for detailed explanations. Here, the horizontal width W of the fourth electrodes 314b satisfies the following equation:

W≦Wp−[(Hp−m)×tan(θ)−n]

Here, Wp represents a width of one pixel unit, Hp represents a length of one pixel unit, m represents a width of a gap between any two adjacent sub-pixels along the Y-direction, and n represents a width of a gap between any two adjacent sub-pixels along the X-direction.

With reference to FIG. 5A and FIG. 5B, for instance, when the stereo display of the present embodiment is being operated, the first electrodes 312a, the second electrodes 312b, and the fourth electrodes 314b may be electrically connected to a first voltage (not shown), and the third electrodes 314a may be electrically connected to a second voltage (not shown). Thereby, the third electrodes 314a may shield light, while the fourth electrodes 314b allow light to pass through. In detail, through the design of the horizontal width W of the fourth electrodes 314b, the light emitted from the pixel regions L for the left eye of a viewer is merely transmitted to the left eye. Simultaneously, the light emitted from the pixel regions R for the right eye of the viewer is merely transmitted to the right eye. As such, the parallax barrier panel 310 described in the present embodiment can further resolve problems caused by color aberration.

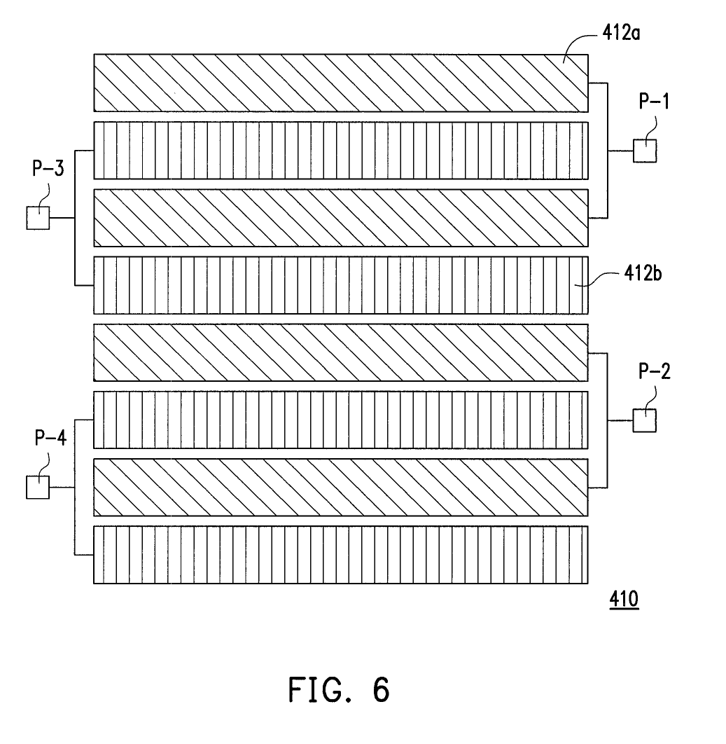

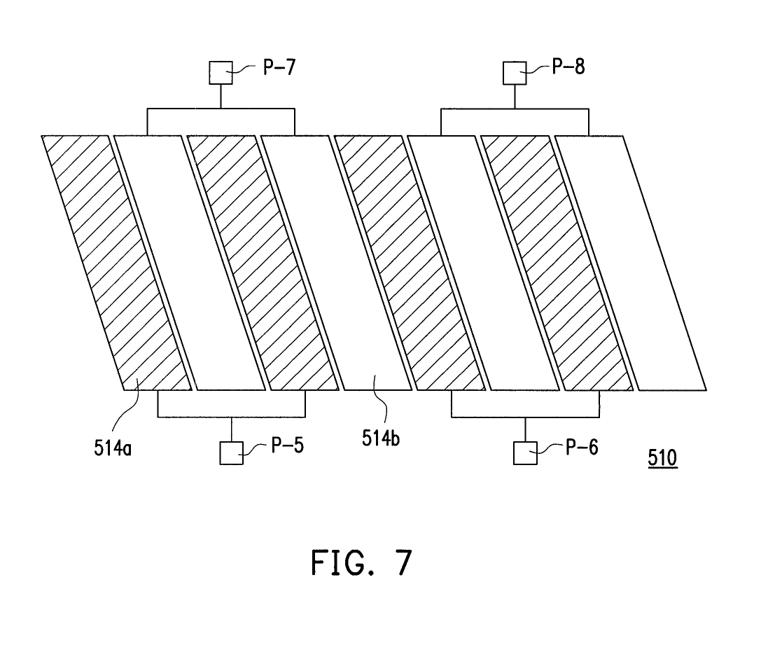

FIG. 6 is a schematic top view illustrating a parallax barrier panel 410 according to an embodiment of the invention. To elaborate the invention, the third electrodes and the fourth electrodes are omitted in FIG. 6. With reference to FIG. 6, according to the present embodiment, the first electrodes 412a may be divided into a first group and a second group based on the electrical connection, and the second electrodes 412b may be divided into a third group and a fourth group based on the electrical connection. Each of the first, second, third, and fourth groups is electrically connected to one of the corresponding input pads P-1, P-2, P-3, and P-4, respectively. In the present embodiment, the first and second electrodes are electrically connected to the corresponding input pads as described in the previous embodiments, while the invention is not limited thereto.

FIG. 7 is a schematic top view illustrating a parallax barrier panel 510 according to an embodiment of the invention. To elaborate the invention, the first electrodes and the second electrodes are omitted in FIG. 7. With reference to FIG. 7, according to the present embodiment, the third electrodes 514a may be divided into a first group and a second group based on the electrical connection, and the fourth electrodes 514b may be divided into a third group and a fourth group based on the electrical connection. Each of the first, second, third, and fourth groups is electrically connected to one of the corresponding input pads P-5, P-6, P-7, and P-8, respectively. In the present embodiment, the third and fourth electrodes are electrically connected to the corresponding input pads as described in the previous embodiments, while the invention is not limited thereto.

In another embodiment, the first, second, third, and fourth electrodes in the parallax barrier panel may be collectively applied in the embodiments shown in FIG. 6 and FIG. 7. That is to say, according to the present embodiment, the first electrodes 412a may be divided into a first group and a second group based on the electrical connection, and the second electrodes 412b may be divided into a third group and a fourth group based on the electrical connection. The first and second electrodes 412a and 412b divided into the first, second, third, and fourth groups may be electrically connected to the corresponding input pads P-1, P-2, P-3, and P-4, respectively. In addition, the third electrodes 514a may be divided into a first group and a second group based on the electrical connection, and the fourth electrodes 514b may be divided into a third group and a fourth group based on the electrical connection. The third and fourth electrodes 514a and 514b divided into the first, second, third, and fourth groups may be electrically connected to the corresponding input pads P-5, P-6, P-7, and P-8, respectively.

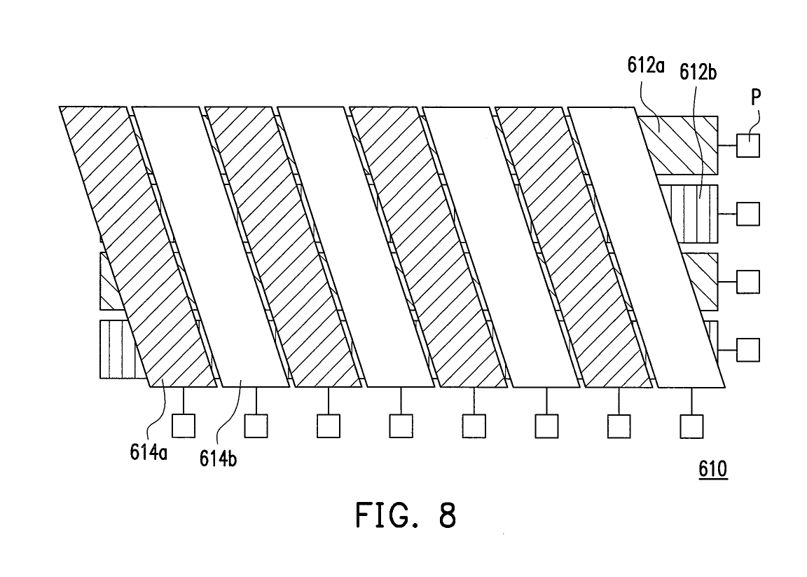

FIG. 8 is a schematic top view illustrating a parallax barrier panel 610 according to an embodiment of the invention. With reference to FIG. 8, each of the first electrodes 612a, the second electrodes 612b, the third electrodes 614a, and the fourth electrodes 614b is electrically connected to one of the corresponding input pads P, respectively.

In light of the foregoing, through the electrical connection of the first, second, third, and fourth electrodes in each parallax barrier panel described in the previous embodiments, the parallax barrier panel of the invention may control the electrodes in a relatively diverse manner. For instance, through electrical operation on the electrodes divided into groups, the display may partially achieve the stereo display effect and partially displays two-dimensional images.

To sum up, the extension direction of the first and second electrodes on the first substrate is parallel to the X-direction, the extension direction of the third and fourth electrodes alternately arranged on the second substrate is not parallel to the

X-direction, and there is an included angle θ between the Y-direction and the extension direction of the third and fourth electrodes. Hence, the inclined configuration of the third and fourth electrodes in the parallel barrier panel of the invention may resolve the color shift issue caused by the conventional vertical arrangement of electrodes. Moreover, the designed width of the inclined electrodes in the parallel barrier panel as described in the invention may further improve the shielding effect. Besides, the stereo display is equipped with the aforesaid parallax barrier panel in the invention; thus, the color aberration issue resulting from different viewing angles can be better resolved, and the stereo display effect of the stereo display can be significantly improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A stereo display comprising:
a display panel comprising a pixel array, the pixel array having a plurality of pixel units, each of the pixel units including a plurality of sub-pixels, the plurality of sub-pixels being arranged along an X-direction and an Y-direction to form the pixel array; and
a parallax barrier panel located at one side of the display panel and comprising:
a first substrate;
a plurality of first electrodes and a plurality of second electrodes, the first electrodes and the second electrodes being arranged on the first substrate alternately, wherein an extension direction of the first electrodes and the second electrodes is parallel to the X-direction;
a second substrate located opposite to the first substrate;
a plurality of third electrodes and a plurality of fourth electrodes, the third electrodes and the fourth electrodes being arranged on the second substrate alternately, wherein an included angle θ between the Y-direction and an extension direction of the third electrodes and the fourth electrodes is substantially greater than 0° and smaller than 45°; and
a birefringence medium located between the first substrate and the second substrate.

2. The stereo display as recited in claim 1, wherein the first electrodes, the second electrodes, and the third electrodes are electrically connected to a first voltage, and the fourth electrodes are electrically connected to a second voltage; or the second electrodes, the third electrodes, and the fourth electrodes are electrically connected to the first voltage, and the first electrodes are electrically connected to the second voltage; or the first electrodes, the second electrodes, and the fourth electrodes are electrically connected to the first voltage, and the third electrodes are electrically connected to the second voltage.

3. The stereo display as recited in claim 1, wherein each of the sub-pixels has a short-side length a and a long-side length b, and the included angle θ between the Y-direction and the extension direction of the third electrodes and the fourth electrodes satisfies θ=tan⁻¹(a/b).

4. The stereo display as recited in claim 1, wherein a horizontal width W of the fourth electrodes is substantially shorter than a horizontal width of the third electrodes.

5. The stereo display as recited in claim 4, wherein the horizontal width W of the fourth electrodes satisfies:
W≦Wp−[(Hp−m)×tan(θ)−n]
wherein Wp represents a width of one of the pixel units,
Hp represents a length of one of the pixel units,
m represents a width of a gap between any two adjacent sub-pixels along the Y-direction, and
n represents a width of a gap between any two adjacent sub-pixels along the X-direction.

6. The stereo display as recited in claim 1, wherein the sub-pixels in each of the pixel units comprise a first color sub-pixel, a second color sub-pixel, and a third color sub-pixel sequentially arranged along the X-direction.

7. The stereo display as recited in claim 1, wherein the pixel array has a plurality of columns in the Y-direction and a plurality of rows in the X-direction, and the sub-pixels located on the same column have identical color.

8. The stereo display as recited in claim 6, wherein the extension direction of the third electrodes and the fourth electrodes is not parallel to the X-direction, and the included angle θ between the Y-direction and the extension direction of the third electrodes and the fourth electrodes satisfies θ=tan⁻¹(1/3)=18.43°.

9. The stereo display as recited in claim 1, wherein the sub-pixels in each of the pixel units comprise a first color sub-pixel, a second color sub-pixel, a third color sub-pixel, and a fourth color sub-pixel sequentially arranged along the X-direction.

10. The stereo display as recited in claim 1, wherein the third electrodes are divided into a first group and a second group, the fourth electrodes are divided into a third group and a fourth group, and each of the first, second, third, and fourth groups is electrically connected to a corresponding input pad, respectively.

11. The stereo display as recited in claim 1, wherein the first electrodes are divided into a first group and a second group, the second electrodes are divided into a third group and a fourth group, and each of the first, second, third, and fourth groups is electrically connected to a corresponding input pad, respectively.

12. The stereo display as recited in claim 1, wherein each of the third electrodes and each of the fourth electrodes are electrically connected to a corresponding input pad, respectively.

13. The stereo display as recited in claim 1, wherein each of the first electrodes and each of the second electrodes are electrically connected to a corresponding input pad, respectively.

14. A parallax barrier panel comprising:
a first substrate;
a plurality of first electrodes and a plurality of second electrodes, the first electrodes and the second electrodes being arranged on the first substrate alternately, wherein an extension direction of the first electrodes and the second electrodes is parallel to the X-direction;
a second substrate located opposite to the first substrate;
a plurality of third electrodes and a plurality of fourth electrodes, the third electrodes and the fourth electrodes being arranged on the second substrate alternately, wherein an included angle θ between the Y-direction and an extension direction of the third electrodes and the fourth electrodes is substantially greater than 0° and smaller than 45°; and
a birefringence medium located between the first substrate and the second substrate.

15. The parallax barrier panel as recited in claim 14, wherein the first electrodes, the second electrodes, and the third electrodes are electrically connected to a first voltage, and the fourth electrodes are electrically connected to a second voltage; or the second electrodes, the third electrodes, and the fourth electrodes are electrically connected to the first voltage, and the first electrodes are electrically connected to the second voltage; or the first electrodes, the second electrodes, and the fourth electrodes are electrically connected to the first voltage, and the third electrodes are electrically connected to the second voltage.

16. The parallax barrier panel as recited in claim 14, wherein a horizontal width of the fourth electrodes is substantially shorter than a horizontal width of the third electrodes.

17. The parallax barrier panel as recited in claim 14, wherein the third electrodes are divided into a first group and a second group, the fourth electrodes are divided into a third group and a fourth group, and each of the first, second, third, and fourth groups is electrically connected to a corresponding input pad, respectively.

18. The parallax barrier panel as recited in claim 14, wherein the first electrodes are divided into a first group and a second group, the second electrodes are divided into a third group and a fourth group, and each of the first, second, third, and fourth groups is electrically connected to a corresponding input pad, respectively.

19. The parallax barrier panel as recited in claim 14, wherein each of the third electrodes and each of the fourth electrodes are electrically connected to a corresponding input pad, respectively.

20. The parallax barrier panel as recited in claim 14, wherein each of the first electrodes and each of the second electrodes are electrically connected to a corresponding input pad, respectively.
